(19) United States
(12) Patent Application Publication
(10) Pub. No.: US 2010/0195859 A1
(43) Pub. Date: Aug. 5, 2010

(54) Hearing Aid

(75) Inventor: Andrea Angeloni, Massa (IT)

Correspondence Address: SHOEMAKER AND MATTARE, LTD, 10 POST OFFICE ROAD - SUITE 100, SILVER SPRING, MD, 20910, US

(73) Assignee: SONOELETTRONICA DI ANGELONI ANDREA, Massa (IT)

(21) Appl. No.: 12/671,353

(22) PCT Filed: Dec. 27, 2007
(86) PCT No.: PCT/IT2007/000916

§ 371 Date: Jan. 29, 2010

(30) Foreign Application Priority Data
Jul. 30, 2007 (IT) BS2007A000113

(51) Int. Cl. H04R 25/00

(52) U.S. Cl. 381/324

(57) ABSTRACT

A hearing aid having a BTE (behind the ear) section comprising a microphone and an ITE (in the ear) section comprising a circuit, a receiver and a power supply. The microphone is connected to the body of the hearing aid by means of a connection and attachment tube which comprises a hook portion able to produce a flexible hooking of the hearing aid to the ear.

### FIELD OF THE INVENTION

The present invention relates to a hearing aid.

### BACKGROUND OF THE INVENTION

As of today existing hearing aids can be divided into two main groups, those worn inside the ear (ITEs) or those worn behind the ear (BTEs).

The former are characterised by an electronic section, comprising a microphone, circuit and receiver situated behind the ear and by an acoustic section, comprising the curved section, a connection tube and the earpiece, to be placed inside the ear.

BTE hearing aids have a number of limitations. In fact their range of application is limited in that they are used almost exclusively for severe and/or profound deafness. In addition, they produce a sensation of blockage: in fact the human voice and the sounds of the body transported by body tissues which are propagated through the vibrations of the soft walls of the external ear canal generate a sound which, if such is occluded by the cochlea, remain trapped, causing an increase in acoustic pressure on the wall of the eardrum, and causing an unpleasant sensation of occlusion.

Another disadvantage is autophony, making the voice seem unnatural, booming, deep and with an echo effect. This problem is often caused by the occlusion of the external ear canal, since the contribution of bodily conduction to the perception of one's own voice remains trapped in the cavity between the hearing aid and the membrane of the eardrum.

To facilitate greater vocal discrimination of noise and overcome such disadvantages for some years now so-called “open” BTE hearing aids have been introduced on the market to treat slight hearing loss. In this case however, should the response curve require increasing, the acoustic feedback phenomenon is more likely to occur.

No less important, state of the art hearing aids are highly visible and cumbersome; moreover, for people who wear glasses, such hearing aids, especially of the BTE type, may create disturbance.

ITE hearing aids however are composed of an electronic section (comprising a microphone, circuit and receiver) inserted in a made-to-measure shell which blocks the ear canal, and of an acoustic section comprising an empty casing and/or ventilation hole.

Given the improved standards of aesthetics ITE hearing aids are those most in demand by persons suffering from partial hearing loss but they too have drawbacks.

In fact they produce a feeling of blockage and autophony in subjects suffering from slight hearing loss at low frequencies. For hearing aid wearers suffering from decreasing loss on high frequencies the problem remains of distinguishing words from the noise created by the insertion gain.

These drawbacks can only be resolved in part by creating an internal ventilation channel of a rectilinear shape inside the casing which, however, greatly increases the effect of acoustic feedback.

Lastly, hearing aids have been made in which the casing inside the ear contains the circuit and receiver, while the microphone is situated outside the casing, behind the ear. Such hearing aids are known for example by U.S. Pat. No. 5,875,254.

However such hearing aids present drawbacks linked to the fact that it is not possible to attach the microphone to the ear in a stable manner; to overcome such drawbacks the microphones are positioned on the frontal portion of the ear at the entrance of the ear canal and directional microphones are used. These solutions are however aesthetically indiscreet, since the microphone is quite visible to an external observer. In addition the microphone is not free of phenomena of acoustic feedback; moreover the use of a directional microphone does not always provide the best sound reception.

Lastly this way the microphone is not positioned in an optimal position for the comfort of the wearer and during use is subject to shifting making it uncomfortable and dysfunctional.

To summarise, state-of-the-art hearing aids have a number of drawbacks connected essentially with problems of autophony, size, feedback, comfort and stability of attachment.

### SUMMARY OF THE INVENTION

The aim of the present invention is to produce a hearing aid which overcomes the drawbacks specified with reference to the technical note.

Such drawbacks and limitations are resolved by a hearing aid in accordance with claim 1.

Other forms of embodiment of the hearing aid according to the invention are described in the subsequent claims.

### BRIEF DESCRIPTION OF THE DRAWINGS

Further characteristics and advantages of the present invention will be more comprehensible from the description given below of its preferred embodiments, given by way of example and not limited to such, wherein:

FIG. 1 shows a perspective view of a hearing aid according to a form of embodiment of the present invention;

FIGS. 2a, 2b and 2c show cross-section views of the hearing aids in FIG. 1, along the cross-section plane II-II of FIG. 1, according to different forms of embodiment of the present invention;

FIG. 3 shows a cross-section view of detail III of the hearing aid in FIG. 1;

FIG. 4 shows a perspective view of a hearing aid according to a further form of embodiment of the present invention;

FIG. 5 shows a perspective view in separate parts of a hearing aid according to a further form of embodiment of the present invention;

FIG. 6 shows a perspective view of a detail of a hearing aid according to a further form of embodiment of the present invention;

FIGS. 7-9 show perspective views from different angles, of examples of insertion in the ear canal of the hearing aids according to present invention.

### DETAILED DESCRIPTION OF THE INVENTION

The elements or parts of elements shared by the forms of embodiment described below will be indicated with the same numerical references.

With reference to the aforesaid figures, reference numeral 4 is taken to globally denote a hearing aid suitable for inserting in an outer ear canal 8.

The hearing aid 4 comprises a microphone 12 able to pick up sounds from the external environment; such microphone may be of the unidirectional or omnidirectional type.

Advantageously, the hearing aid 4 comprises a circuit electrically connected to the microphone able to amplify the signals received from the microphone 12.

The circuit 16 may, for example, be fitted with digital filters to cut out some frequencies or other devices able to process the sound signal.

The hearing aid 4 also comprises a receiver 20 electrically connected to the circuit 16 and able to convey sounds into the ear canal 8, as well as a power supply 24 of the circuit such as for example, a battery of a known type.

Advantageously, the hearing aid 4 comprises a body of the hearing aid suitable for insertion in the ear canal 8, which houses the circuit 16, the receiver 20 and the power supply 24 internally.

In other words, the body of the hearing aid 28 is an ITE portion of the hearing aid according to the invention, suitable for insertion in the external ear canal 8.

Advantageously, the microphone 12 is situated outside the body of the hearing aid 28 and is connected to it by means of a connection and attachment tube 36 which creates an electrical connection between the circuit 16 and the microphone 12, as well as providing a secure and stable attachment of the microphone to the ear. The microphone is the BTE portion of the hearing aid of the present invention.

Preferably, as will be described in detail below, the connection and attachment tube 36 is configured so as to constitute a support element for the microphone 12 and an attachment element of the hearing aid 4 to the ear 40.

The connection and attachment tube goes from a first extremity 64, where it connects to the microphone 12, to a second extremity 68, where it connects to the body of the hearing aid 28.

According to a form of embodiment, the connection and attachment tube 36 comprises an external casing 44 which contains inside it an electric conductor wire 48 able to form an electrical connection between the microphone 12 and the circuit 16.

By way of example, the external casing 44 is made from non-allergenic, electrically insulated material.

According to one form of embodiment, the connection and attachment tube 36 comprises a core preferably made using a cable, for example in metallic material.

According to one form of embodiment, said core 37 is covered by a sheath 38, for example in polymer material, so as to electrically insulate the core 37. The electrical conductor wires 48 are situated in the space 39 between the core 37 and the tube. Advantageously, the core 37 makes the connection and attachment tube 36 flexible so that in the event of the tube 36 being bent it ensures a flexible effect of the curved tube.

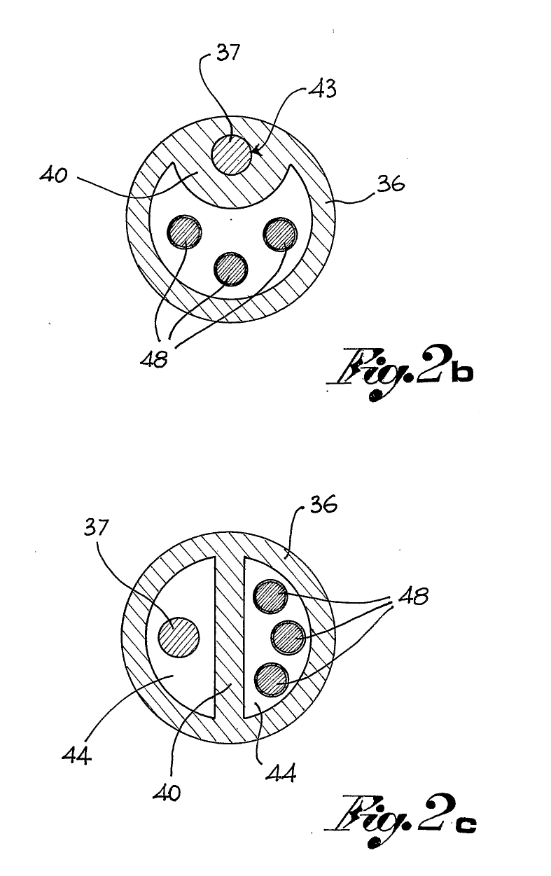

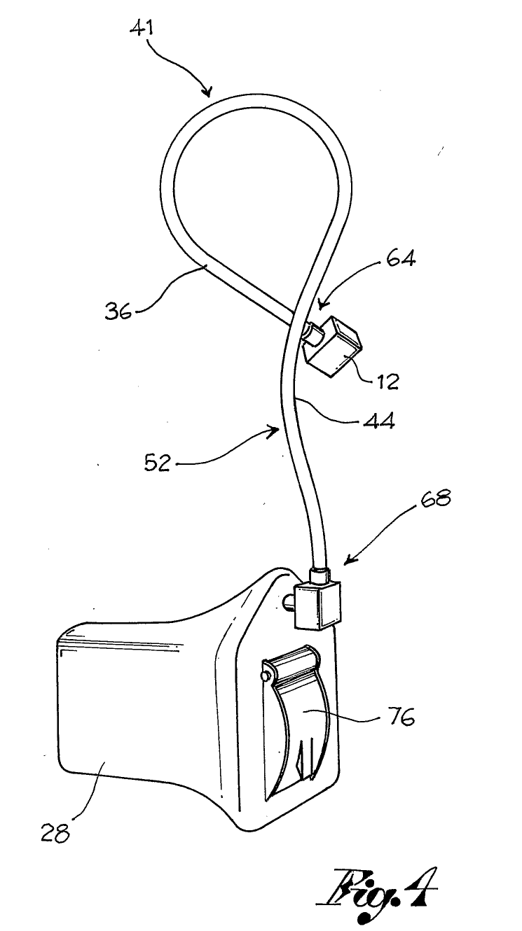

According to one form of embodiment, said space 39 has a circular crown cross-section (FIG. 2a).

According to a further form of embodiment, the internal cross-section of the tube 36 is divided into two parts by an inner septum 40. For example the septum 40 has an arched shape so as to define a ring-shaped seat 43 able to house said core 37 of the connection and attachment tube 36 (FIG. 2b). According to a further form of embodiment, said inner septum 40 divides the tube into two practically symmetrical portions 44, with an essentially semi-circular cross-section, able to house the core 37 and the electrical conductor wires 48 (FIG. 2c). The septum 40 ensures that no contacts and/or friction between the electrical conductor wires 48 and the core 37 occur. In addition, the septum 40 makes the connection and attachment tube 36 more resistant and ensures that the tube 36 maintains its curved configuration.

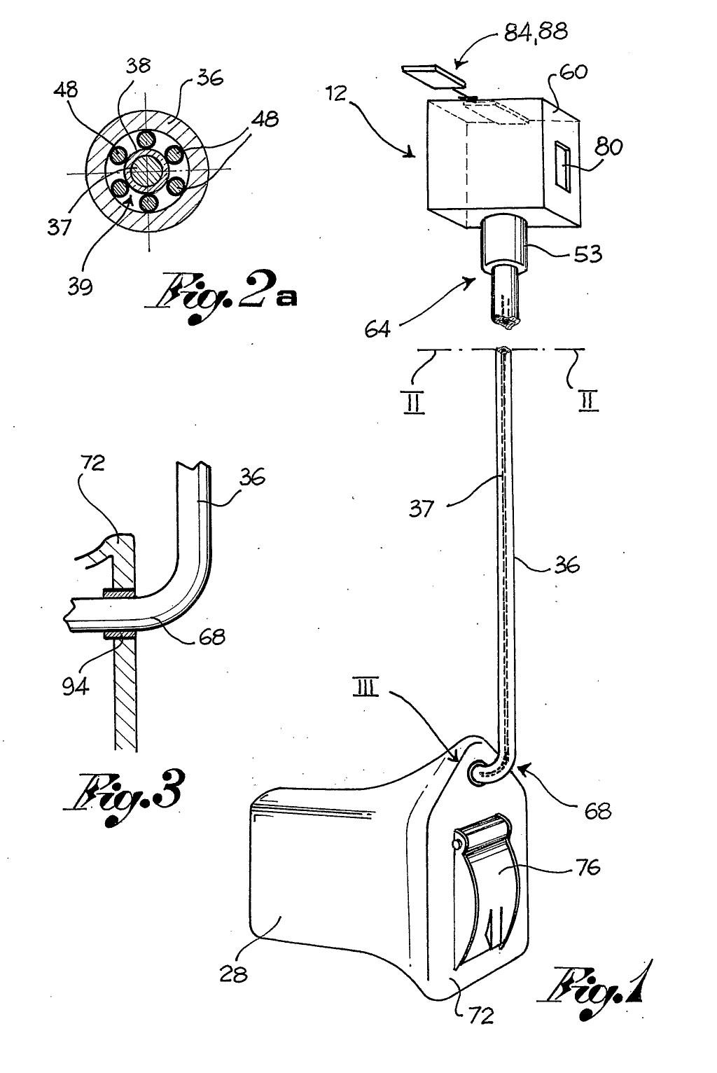

According to one form of embodiment, the connection tube 36 is made in a rectilinear shape (FIG. 1) so that subsequently it can be bent as required in the light of the morphology of the ear which it is to be applied to.

Advantageously, the connection and attachment tube 36 is bent so that, in a rest configuration in which it is not worn by the user, it comprises a hook portion 41 which closes into a ring shape, so as to form a sort of flexible hook able to fasten the hearing aid to the ear.

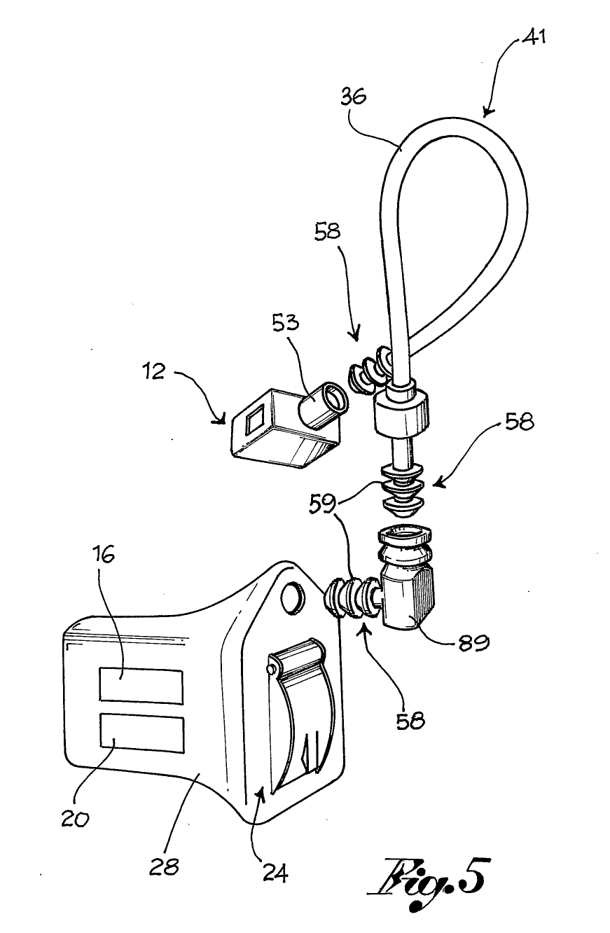

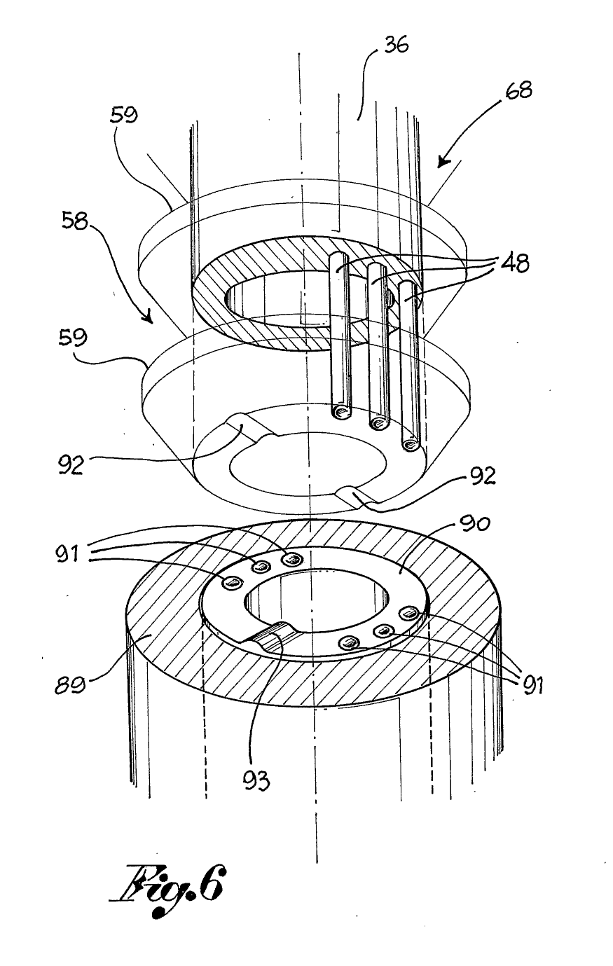

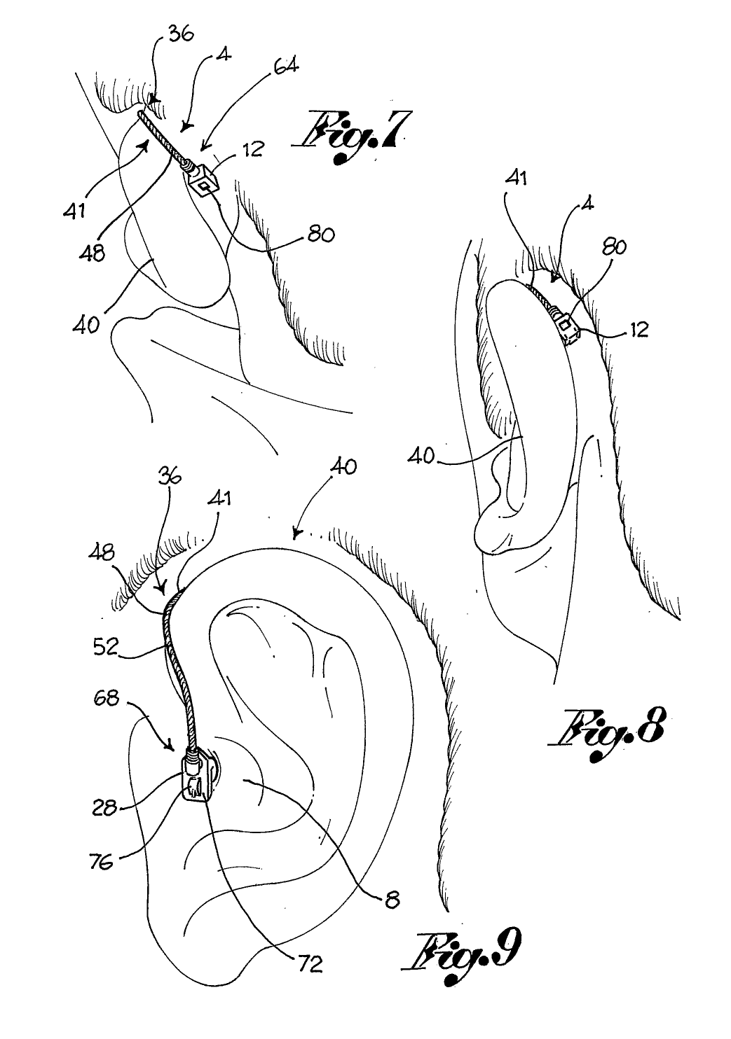

In other words, in a rest position, in which the hearing aid is not worn, the tube closes onto a hook portion 41 (FIGS. 4,5).

Following installation of the hearing aid, the hook portion 41 is flexibly opened and hooked onto the ear. Thanks to the core 37, the hook portion 41 tends to pinch the ear, creating a firm and safe attachment which ensures the immobility of the microphone 12.

Preferably, the hook portion 41 is curved on the side opposite the body of the hearing aid 28 so as to position the microphone 12 in a close position to the ear 40.

Advantageously, the connection and attachment tube 36 has a curved section 52 able to adapt to the morphology of the portion of the ear connected to the head.

Preferably, the hearing aid 4 comprises a containment casing 60 of the microphone 12 which houses the microphone 12.

The connection and attachment tube 36, at its first extremity 64, is connected to the containment casing 60.

According to one form of embodiment, the first extremity 64 has a connection portion 58 able to create an axial connection between the tube and the connectable containment casing 60.

Advantageously the connection portion 58 permits relative rotation between the extremity 64 and the containment casing 60. For example the connection portion 58 comprises at least one tab 59, for example ring-shaped, which by means of a snap coupling, preferably shaped, makes it possible to snap the extremity 64 of the tube 36 onto the casing 60.

For example, the extremity 64 can be snapped onto a collar 53 of the casing 60. This way, thanks to the relative rotation of the casing in relation to the first extremity 64, it is possible to adapt the hearing aid to the exact morphology of the wearer.

According to a further form of embodiment, the connection and attachment tube 36 is made in one piece with the containment casing 60.

The second extremity 68 of the connection and attachment tube 36 is connected mechanically to a closing cap 72 of the body of the hearing aid 28. The closing cap 72 can be removed from the body of the hearing aid 28 so as to enable access to the inside of the body of the hearing aid.

According to one form of embodiment, the closing cap 72 comprises an access hatch 76 to the power supply 24, such as batteries.

According to one form of embodiment, the connection and attachment tube 36, at the second extremity 68, comprises a connection portion 58 able to create an axial connection between the tube and the associable body of the hearing aid 28.

Advantageously, the connection portion 58 permits relative rotation between the second extremity 68 of the tube 36 and the body of the hearing aid 28. For example the connection portion 58 comprises at least one tab 59, for example ring-shaped, which by means of a snap coupling, preferably shaped, makes it possible to snap the second extremity 68 of the tube 36 onto the body of the hearing aid 28. This way, thanks to the relative rotation of the body 28 in relation to the second extremity 68, it is possible to adapt the hearing aid to the exact morphology of the ear of the wearer.

In addition, by rotating the tube by approximately 180 degrees in relation to the body of the hearing aid 28, it's possible to change from a configuration of the hearing aid for the right ear to a configuration of the hearing aid for the left ear. According to a further form of embodiment, between the body of the hearing aid 28 and the second extremity 68 of the tube 36 there is a joint 89 which comprises a collar able to receive the connection portion 58 of the tube 36 and a further connection portion 58 suitable for attachment to the body of the hearing aid 28.

According to a further possible form of embodiment, the connection and attachment tube 36, at the second extremity 68, comprises electric wires 48 at least partially sunk and fixed in the thickness of the wall of the tube 36; the second extremity 68 comprises a pair of slots 92, preferably positioned at 180 degrees from each other.

The body of the hearing aid 28, preferably the joint 89, comprises an electric connection terminal board 90 which printed electric circuit boards 91 are sunk into, electrically connected to the electric components housed in the body of the hearing aid 28.

Preferably, the electric connection terminal board 90 comprises two series of printed electric circuit boards 91, positioned symmetrically to each other at 180 degrees, so that by turning the second extremity 68 by 180 degrees in relation to the printed electric circuit boards 91, to change from the right configuration to the left configuration and/or vice versa, the electrical connection between the body of the hearing aid 28 and the tube 36 is always ensured.

In other words, the electric wires 48 of the second extremity 68 overlap the printed electric circuit boards 91 after connecting the second extremity 68 of the tube 36 to the body, creating an electrical connection between the tube and the body of the hearing aid 28.

The electric connection terminal board 90 comprises at least one raised part 93 able to form a shaped coupling with said slots 92.

The slots 92 of the second extremity 68, positioned at 180 degrees to each other, couple with the raised part 93 situated on the joint 89 and ensure the correct angular position and relative electrical connection between the second extremity 68 of the tube 36 and the body of the hearing aid 8.

According to one form of embodiment, the second extremity 68 of the tube 36 fits into the closing cap 72 of the body, by means of interposed bushing 94, for example in polymeric material, to prevent friction and excessive curvature of the tube 36 at the second extremity 68.

According to a further form of embodiment, the connection and attachment tube 36, at the second extremity 68, is made in one piece with the closing cap 72 of the body of the hearing aid 28.

The containment casing 60 of the microphone 12 comprises at least one aperture 80 for the connection of the microphone 12 with the outside of the casing 60.

Preferably, said aperture 80 faces the opposite way to the body of the hearing aid 28 as well as to a support surface of the relative ear.

Preferably, the containment casing 60 of the microphone comprises blocking devices 84 of the microphone inside it.

For example, the blocking devices 84 comprise at least one strip 88 able to flexibly direct the microphone 12 against an inner wall of said casing, opposite the said strip. Advantageously, the blocking devices, once removed, enable extraction of the microphone 12 from its casing 60.

According to a possible form of embodiment, aimed at improving the performance of the hearing aid as regards autophony, the body of the hearing aid 28 may comprise at least one ventilation channel (not shown) able to allow the passage of air through the body of the hearing aid 28, so as to allow the ear canal 8, which receives the body of the hearing aid 28, to communicate with the external environment. The phenomenon of autophony can also be reduced by using a casing or body of the hearing aid 28 which is smaller than the ear canal, avoiding the ‘Larsen’ phenomenon in any case thanks to the specific distance and position of the microphone, behind the ear which thus constitutes a further obstacle to the onset of the ‘Larsen’ effect. For example, the body of the hearing aid 28 may be a truncated cone shape with a slot 90, suitable for application in very small ear canals (FIG. 2).

As may be appreciated from the above description, the hearing aid according to the invention makes it possible to overcome the drawbacks referred to in the technical note.

Specifically, the hearing aid according to the present invention makes it possible to distance the microphone from the receiver eliminating the phenomenon of acoustic feedback, at the same time permitting a variety of applications ranging from medium hearing loss to severe deafness, impossible to achieve with known, state-of-the-hearing aids.

From an aesthetic point of view too the hearing aid according to the present invention is extremely advantageous given that it makes for particularly limited dimensions of the external portion, making it comparable to a hearing aid of the ITE type.

The dimensions and conformation of the hearing aid of the present invention also permit greater comfort and convenience.

In fact, the connection and attachment tube has such flexible properties as to make it suitable for any anatomical conformation of the wearer. Thanks to the elasticity of the tube, given by the core of the tube, the tube acts as a hook on the ear and ensures secure attachment over time, preventing shifting during normal use.

In addition, the tube has such characteristics of dimension and weight as to make it practically invisible from outside and is not perceived by the wearer.

Advantageously, thanks to the inner core, the connection and attachment tube can be adapted to any morphology of the wearer. In addition the hearing aid can be converted from right to left and vice versa by exploiting the bendiness of the tube. In fact, the core means that following a rotation of 180 degrees of the tube, the said tube maintains the new curvature assumed.

The operation of conversion from a right to left configuration and vice versa may be facilitated by the use of connection portions at the extremities of the tube.

It is in fact possible to convert the hearing aid from right to left by using the rotatable joint between the second extremity of the tube and the body of the hearing aid.

The connection and attachment tube has a double shaping or curvature, given by the hook portion and by the curved section, making perfect adherence possible both on the outside part of the ear and in the part positioned behind the ear.

In other words, the connection tube has an anatomical form which ensures comfort and convenience and which at the same time improves the acoustic features of the hearing aid.

The hearing aid of the present invention is free from feedback phenomena, given that the microphone is situated at a considerable distance from the receiver.

The hearing aid therefore offers a practically unlimited range of applications in cases of over 80 dB of hearing loss.

Furthermore, the BTE portion of the present hearing aid is particularly small and light in that it comprises solely the microphone. Specifically, the relatively large and heavy components of the hearing aid, such as the battery and the electronic components are in fact all contained in the body of the hearing aid lodged in the ear canal.

A technician skilled in this area, may make numerous modifications and adjustments to the hearing aid described above so as to satisfy contingent and specific requirements, all moreover contained within the sphere of the invention as defined by the following claims.

1-30. (canceled)

31. Hearing aid, comprising
a microphone, a circuit electrically connected to the microphone and able to amplify the signals received from the microphone, a receiver electrically connected to the circuit and able to transmit sounds to the ear canal, power supply of said circuit,
the hearing aid comprising a body of the hearing aid, which houses inside it the circuit, the receiver and the power supply, the body of the hearing aid being suitable for insertion in said ear canal,
wherein
the microphone is situated outside the body of the hearing aid and is connected to it by means of a connection and attachment tube which creates an electric connection between the circuit and the microphone and which attaches the hearing aid to the ear,
the connection and attachment tube goes from a first extremity, where it connects to the microphone, to a second extremity, where it connects to the body of the hearing aid,
the connection and attachment tube comprises a hook portion configured so as to constitute a support element of the microphone and elastic element for hooking the microphone to the ear.

32. Hearing aid according to claim 31, wherein the connection and attachment tube comprises an external casing which contains inside it at least one electric conductor wire able to form an electric connection between the microphone and the circuit.

33. Hearing aid according to claim 32, wherein said external casing is made from non-allergic, electrically insulated material.

34. Hearing aid according to claim 31, wherein the connection and attachment tube comprises a core, able to make the hook portion of the connection and attachment tube flexible.

35. Hearing aid according to claim 34, wherein said core comprises a cable in metallic material.

36. Hearing aid according to claim 34, wherein said core is covered by a sheath able to electrically insulate the core.

37. Hearing aid according to claim 34, wherein the electrical conductor wires are situated in the space found between the core and the external casing of the tube.

38. Hearing aid according to claim 37, wherein said space has a circular crown cross-section.

39. Hearing aid according to claim 31, wherein the inner section of the tube is divided into two parts by an inner septum.

40. Hearing aid according to claim 39, wherein the septum has an arched shape so as to define a ring-shaped seat able to house said core of the connection and attachment tube.

41. Hearing aid according to claim 39, wherein the inner septum divides the tube into two practically symmetrical portions, able to respectively house the core and the electrical conductor wires.

42. Hearing aid according to claim 31, wherein the connection tube is made in a rectilinear shape and is subsequently bent to create the hook portion in the light of the morphology of the ear, the core ensuring that it maintains its curved configuration and the flexible effect of the hook portion.

43. Hearing aid according to claim 31, wherein the connection and attachment tube is bent so that, in a rest configuration in which it is not worn by the user, it comprises a hook portion which closes into a ring shape, so as to form a sort of flexible hook able to fasten the hearing aid to the ear.

44. Hearing aid according to claim 31, wherein the hook portion is curved on the side opposite the body of the hearing aid so as to position the microphone in a close position to the ear.

45. Hearing aid according to claim 31, wherein the connection and attachment tube has a curved section able to adapt to the morphology of the portion of the ear connected to the head.

46. Hearing aid according to claim 31, wherein the first extremity has a connection portion able to create an axial connection between the tube and the connectable containment casing and to allow relative rotation between the extremity and the containment casing.

47. Hearing aid according to claim 46, wherein the connection portion comprises at least one tab, which makes it possible to connect the extremity of the tube and the casing using a shaped coupling.

48. Hearing aid according to claim 31, wherein the connection and attachment tube at the second extremity comprises a connection portion able to create an axial connection between the tube and the connectable body of the hearing aid and to allow relative rotation between the second extremity and the containment casing and the body of the hearing aid.

49. Hearing aid according to claim 48, wherein the connection portion comprises at least one tab, which makes it possible to connect the second extremity of the tube and the body of the hearing aid using a shaped coupling.

50. Hearing aid according to claim 31, wherein the connection and attachment tube, at the second extremity, comprises electric wires at least partially sunk and fixed in the thickness of the wall of the tube and the body of the hearing aid comprises an electric connection terminal board which printed electric circuit boards are sunk into, electrically connected to the electric components housed in the body of the hearing aid.

51. Hearing aid according to claim 50, wherein the electric connection terminal board comprises two series of printed electric circuit boards, positioned symmetrically to each other at 180 degrees, so that by turning the second extremity by 180 degrees in relation to the printed electric circuit board, to change from the right configuration to the left configuration and/or vice versa, the electrical connection between the body of the hearing aid and the connection and attachment tube is always ensured.

52. Hearing aid according to claim 50, wherein the second extremity comprises a pair of slots and the body of the hearing aid comprises a raised part able to create a shaped coupling with said slots so as to ensure the alignment and electrical connection between the printed electric circuit board and the electric wires of the tube.

53. Hearing aid according to claim 52, wherein the slots of the second extremity are positioned at 180 degrees to each other to ensure the correct angular position and relative electrical connection between the second extremity of the tube and the body of the hearing aid in passing from a right to left configuration of the hearing aid.

54. Hearing aid according to claim 31, wherein the second extremity of the tube fits into the closing cap of the body of the hearing aid, by means of interposed bushing.

55. Hearing aid according to claim 31, wherein the connection and attachment tube is made in one piece with the containment casing of the microphone and/or with a closing cap of the body of the hearing aid.

56. Hearing aid according to claim 31, wherein the containment casing of the microphone comprises at least one aperture for the connection of the microphone with the outside of the casing.

57. Hearing aid according to claim 56, wherein said aperture faces the opposite way to the body of the hearing aid as well as to a support surface of the relative ear.

58. Hearing aid according to claim 31, wherein the containment casing of the microphone comprises blocking devices of the microphone inside it.

59. Hearing aid according to claim 58, wherein said blocking devices comprise at least one strip able to flexibly direct the microphone against an inner wall of said casing.

60. Hearing aid according to claim 31, wherein said body of the hearing aid comprises at least one ventilation channel able to allow the passage of air through the body of the hearing aid, so as to allow the ear canal, which receives the body of the hearing aid, to communicate with the external environment.
